(19) United States
(12) Patent Application Publication
(10) Pub. No.: US 2006/0207383 A1
(43) Pub. Date: Sep. 21, 2006

(54) Motorcycle gear shifter shoe guard

(76) Inventor: Cory Lee James, Winston-Salem, NC (US)

Correspondence Address: Cory Lee James, 314 Maynard Dr., Winston-Salem, NC, 27107, US

(21) Appl. No.: 11/069,695

(22) Filed: Mar. 1, 2005

(51) Int. Cl. G05G 1/16

(52) U.S. Cl. 74/563

(57) ABSTRACT

This invention pertains to keeping your shoes free from black marks and scuffs. The gear shifter shoe guard was designed with two separate parts. First being a rubber sleeve smaller around than the gear shifter on a street bike. This rubber sleeve is glued to the inside of a foam sleeve, which is the second part. With the rubber sleeve meeting the rubber on the gear shifter, this will create friction that will not allow the gear shifter shoe guard to fall off while switching gears. To mount the gear shifter shoe guard to the gear shifter, you will need to take your two index fingers at the open end and stretch the gear shifter shoe guard out. Slide the gear shifter shoe guard on the gear shifter all the way until you cover up the gear shifter completely, and it will take its original shape.

The MOTORCYCLE GEAR SHIFTER SHOE GUARD is designed for riders who love to ride with light-colored boots, and white shoes. Also, it is great for riding with flip-flops at the beach. Too me, keeping my shoes clean without putting tape on my motorcycle gear shifter or a sock over my shoe is important. The tape does not last, the sock falls off your shoe, and it simply is not stylish. This is why I designed the MOTORCYCLE GEAR SHIFTER SHOE GUARD. It is stylish, comfortable, and affordable. Also, it is easy to put on and take off the motorcycle gear shifter.

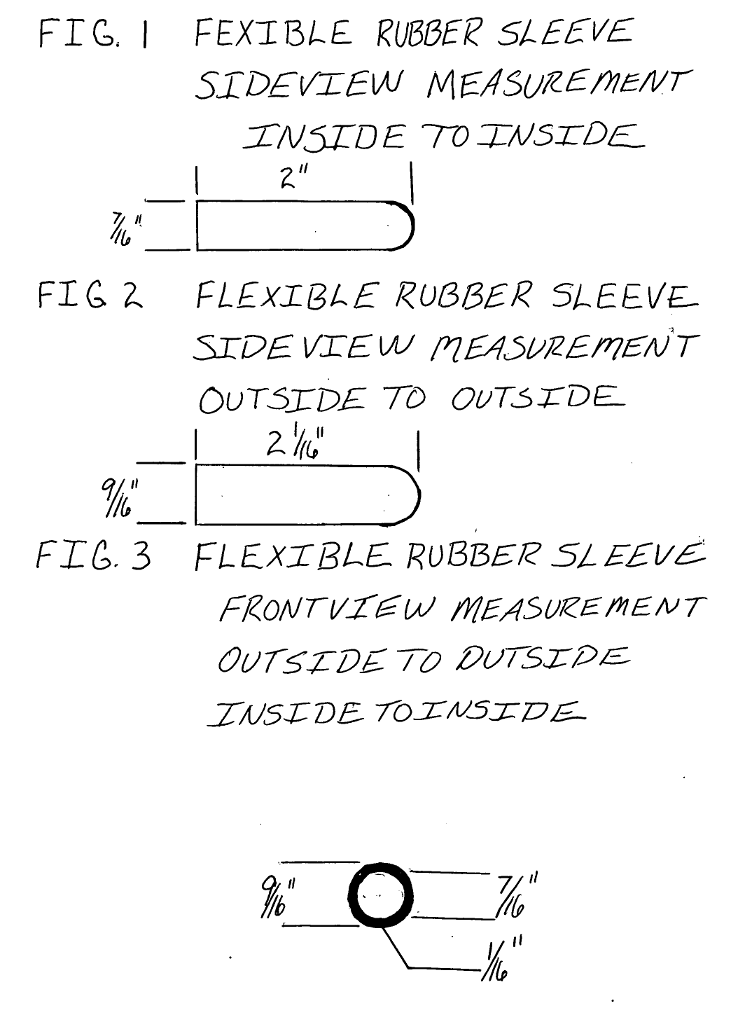

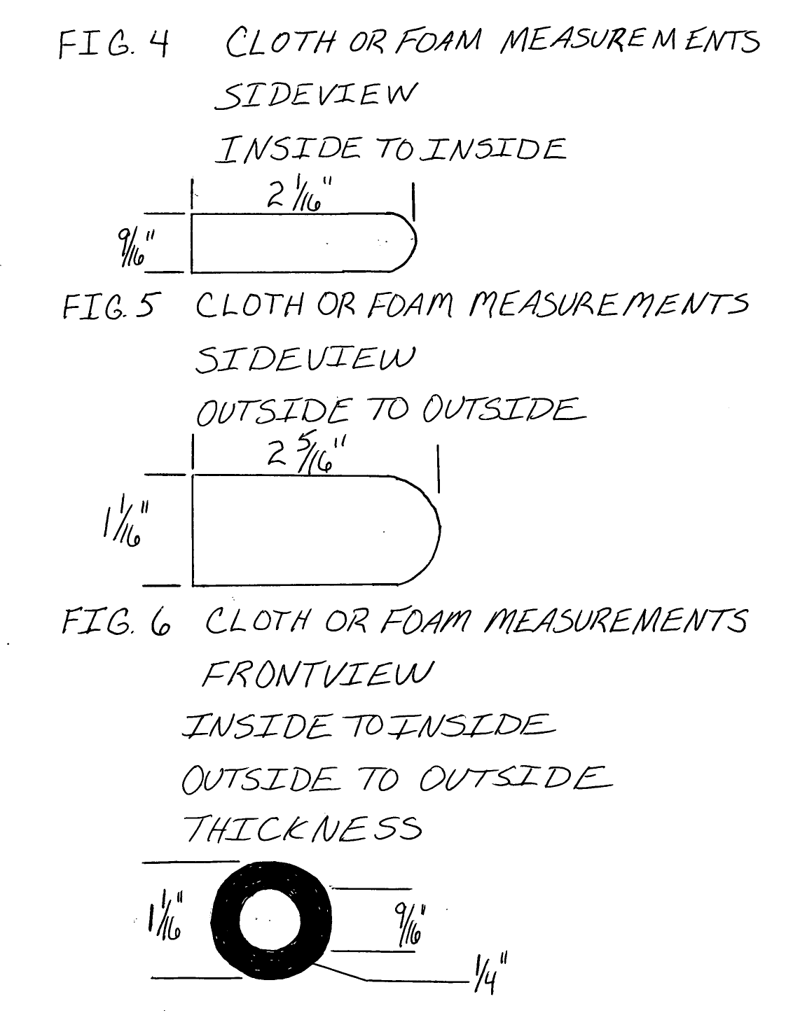

On the gear shifter it has a black rubber piece that will keep the MOTORCYCLE GEAR SHIFTER SHOE GUARD from coming off. That rubber piece is what causes shoes to get marked up and your feet with a raw spot if riding with flip-flops. The way it works is the MOTORCYCLE GEAR SHIFTER SHOE GUARD has a rubber sleeve inside that is smaller in diameter than the gear shifter. (See FIGS. 1,2,3,7). With the two rubber pieces together, they will create friction allowing the gear shifter shoe guard to stay on. This is the first part and size of the MOTORCYCLE GEAR SHIFTER SHOE GUARD.

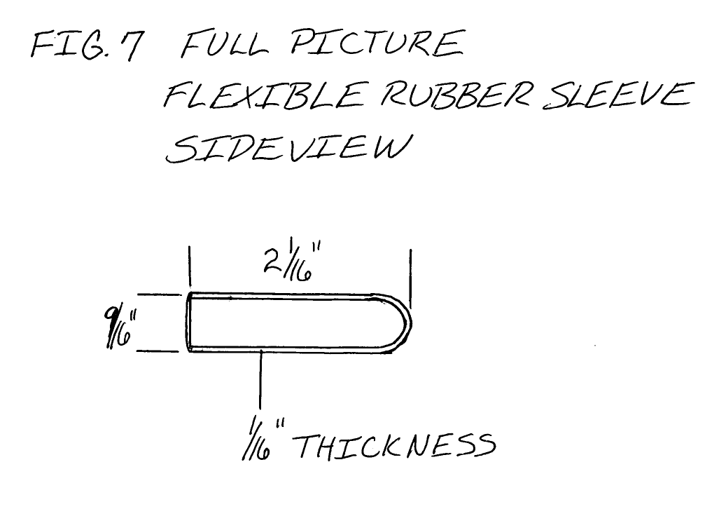

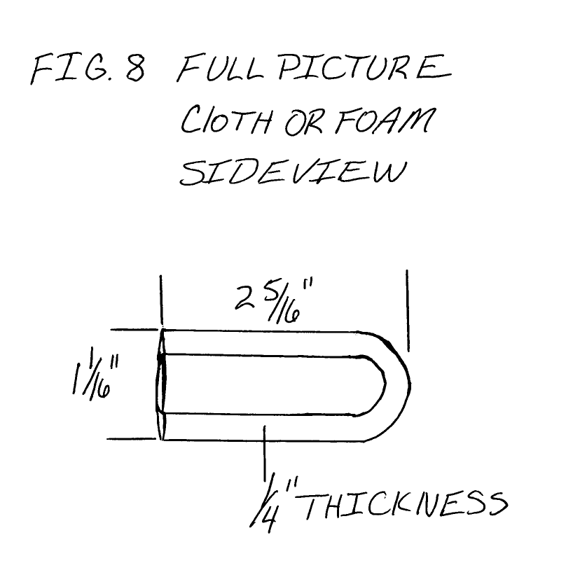

The second part of the design is a fabric or foam material that will be manufactured both ways, which will be durable, and have a die color that will not bleed. The fabric or foam is glued to the inner rubber piece inside with a durable water-based glue that will be environmentally safe and approved upon manufacturing. (See FIGS. 4,5,6,8).

This product will be very simple to make and does not have many parts. One size will fit all street bikes (Honda, Suzuki, Yamaha, Kawasaki, and etc). I feel that the MOTORCYCLE GEAR SHIFTER SHOE GUARD will be a big success in motorcycle accessories. Now we can finally switch gears and not mark up those brand new shoes or boots.

What I claim as my invention is:

1. The Motorcycle Gear Shifter Shoe Guard which was designed to put on a motorcycle gear shifter that extends along side the front left hand corner of the motorcycle. This will protect the motorcyclist's shoe from getting scuffed up from the rubber piece on the gear shifter. This consists of:
(a) A rubber inner sleeve that is flexible, smaller in diameter than the gear shifter itself, and will allow the Motorcycle Gear Shifter Shoe Guard to give good results and not slip off the gear shifter.
(b) An outer cloth or foam sleeve attached to the inner rubber sleeve which will give maximum results for protecting the motorcyclist's shoe while switching gears.
(c) Whereby the two components put together with durable water-based glue which with the right size will still allow room for the motorcyclists to switch gears and give maximum results with protecting the shoe as well.
